(19) United States
(12) Patent Application Publication
(10) Pub. No.: US 2011/0298690 A1
(43) Pub. Date: Dec. 8, 2011

(54) Multiple, Independent, Pull-out Screens Housed in a Main Display

(76) Inventor: Deirdre Ann REILLY, Reading, MA (US)

(21) Appl. No.: 13/156,236

(22) Filed: Jun. 8, 2011

Related U.S. Application Data
(60) Provisional application No. 61/352,708, filed on Jun. 8, 2010.

(51) Int. Cl. G09G 5/00

(52) U.S. Cl. 345/1.1

(57) ABSTRACT

A multiple display device having a main display screen and a display housing. The display device comprises of a plurality of extended display screens varying in sizes that can be pulled from a plurality of screen slots peripherally positioned about the display housing. Each of the plurality of extended display screens can be extracted and activated independently by means of a screen selection interface to provide additional viewing area on a computing device, and to run multiple, independent applications at once on the same device.

The current application claims a priority to the U.S. Provisional Patent application Ser. No. 61/352,708 filed on Jun. 8, 2011.

### FIELD OF THE INVENTION

The present invention relates generally to computer display with a plurality of extended computer displays. More specifically, the plurality of extended computer displays are housed within the main computer display and can be pulled out for additional screens for use.

### BACKGROUND OF THE INVENTION

Traditionally, laptops and personal computers are connected to at least one display monitor. With increasing need to multitask, users have hooked several monitors to one computer to provide a larger and wider viewing area capable of viewing several computer applications simultaneously. However, the plurality of monitors being used for multi-tasking occupies a large amount of space on a user's table or desk. At some times, when the user is not multitasking, the extra monitors are unnecessary and simply occupies space on the user's desk. It is an objective of the present invention to integrate the functionality of multiple monitors in multiple sizes into one physical monitor housing for more functional use, convenience and preservation of space. The invention is intended to be applicable to everyday personal and business computer (laptop, PC, and additionally other devices including iphone, ipad) use, focusing on providing a brand-new way to view multiple screens at once, to offer varying screen sizes within one device, and ultimate multi-screen portability.

### BRIEF DESCRIPTION OF THE DRAWINGS

FIG. 1 is a perspective view of the present invention in the embodiment of a monitor with the a first extended display screen being fully extended and a second extended display screen partially extended from the display housing.

FIG. 2 is a rear cross sectional view of the present invention in the embodiment of a monitor showing an interior view of the screen slot.

FIG. 3 is a left side cross sectional view of the interior of the screen slot. The shape of the screen slot and the arm track is shown .

FIG. 4 is a perspective view of an individual extended display screen in which a detailed view is taken and shown in FIG. 5 and FIG. 6.

FIG. 5 is a detailed view of the track arm showing the notch that allows the track mount to even slide within the arm track within the screen slot.

FIG. 6 is a detailed view of the extending arm connecting the extended display screen to the track mount.

FIG. 7 is a perspective view of another embodiment of the present invention where the display housing is fixed to a laptop. The plurality of extended display screens is shown extended out for use.

FIG. 8 is a perspective view of the embodiment of the present invention where the display housing is fixed to a laptop. The plurality of extended display screens is shown retracted into the display housing.

### DETAIL DESCRIPTIONS OF THE INVENTION

All illustrations of the drawings are for the purpose of describing selected versions of the present invention and are not intended to limit the scope of the present invention.

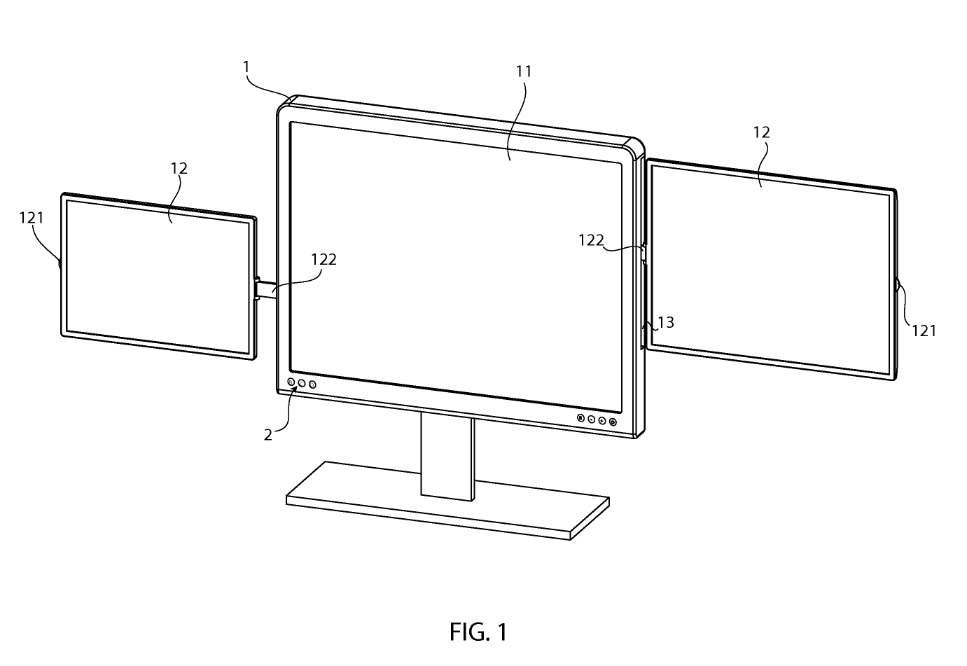

In reference to FIG. 1, the present invention is a display device comprising a main display screen 11, a plurality of extended display screens 12, and a plurality of screen slots 13. The main display screen 11, the plurality of extended display screen 12s, and the plurality of screen slots 13 are all positioned in the display housing 1. The display housing 1 is the main body of the present invention that binds and holds all of the components. The main display screen 11 is the original screen that is used regularly for any and all computer applications. The main display screen 11 is positioned on and occupies entire area of the front face of the display housing 1. The plurality of screen slots 13 are recessed spaces that are peripherally positioned about the display housing 1. The plurality of extended display screens 12 is positioned in the plurality of screen slots 13 and can be pulled out when required to be used. In the preferred embodiment of the present invention, there are two screen slots 13 with two extended display screens 12. However, in other embodiments of the present invention, provided that the display housing 1 is thicker, additional extended display screens 12 may extended from the display housing 1.

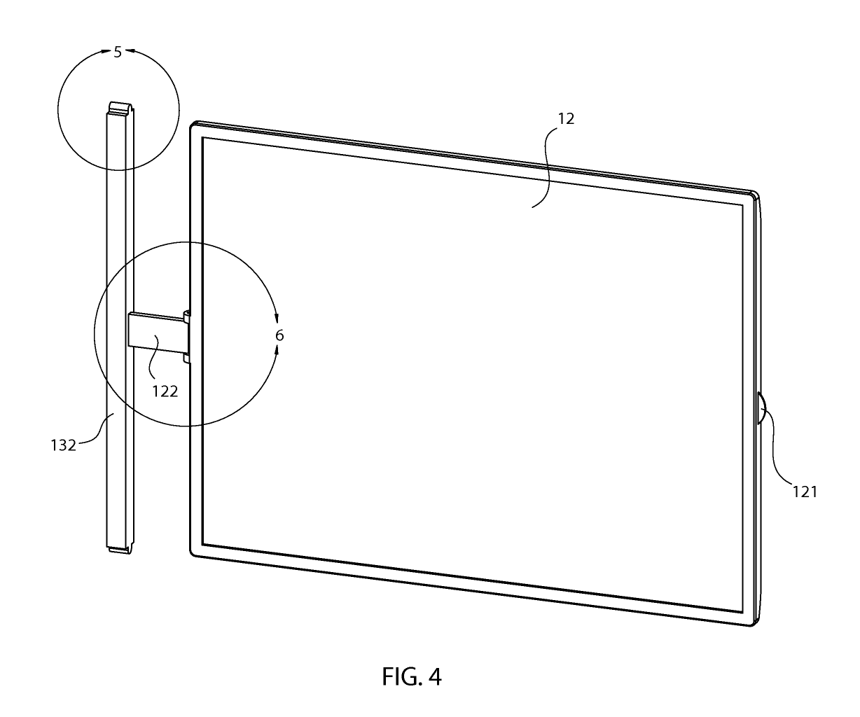

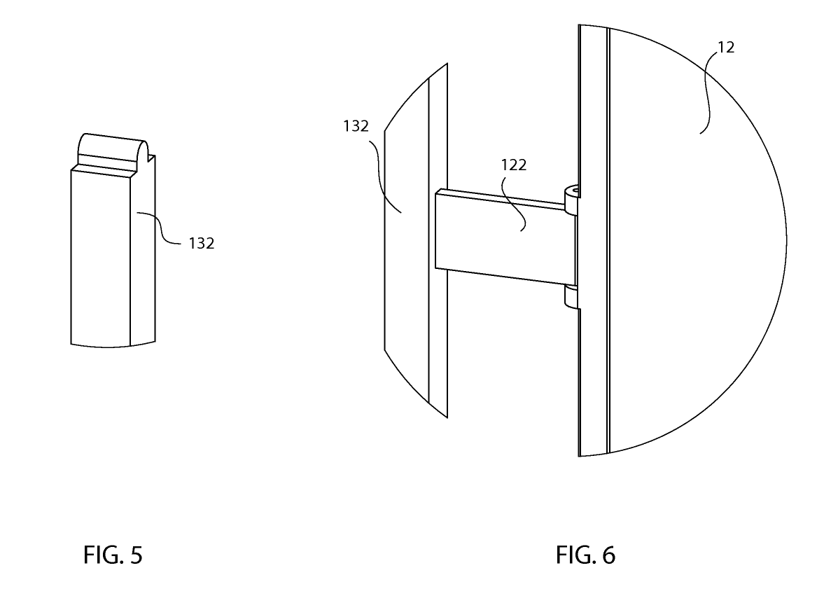

In reference to FIG. 1 and FIG. 4, to pull the plurality of extended display screens 12, each extended display screen 12 comprises a pull tab 121 and an extending arm 122. The extending arm 122 is jointly connected peripherally to the each of the extended display screen 12. In the preferred embodiment of the present invention, the extending arm 122 is connected to the extended display screen 12 by a hinge type connection. The hinge type of connection allows the user to flip the extended display screen 12 towards and away from the user. This allows the user to adjust the extended display screen 12 to a comfortable viewing angle. However, in other embodiment of the present invention, the extending arm 122 can be connected by ball bearings or any other suitable joint connection. Additionally, in the preferred embodiment of the present invention, the extending arm 122 is made from a metal material for added strength and durability. However, in other embodiments of the present invention, the extending arm 122 can be made of any other strong durable materials. The pull tab 121 is a flat area that is peripherally positioned on the extended displays opposite of the extending arm 122. The pull tab 121 allows the user to pull the extended displays from the plurality of screen slots 13. The extending arm 122 is able to support and hold the extended display screens 12 away from the display housing 1. The extended display screens 12 are connected for power and video signal through the extending arm 122.

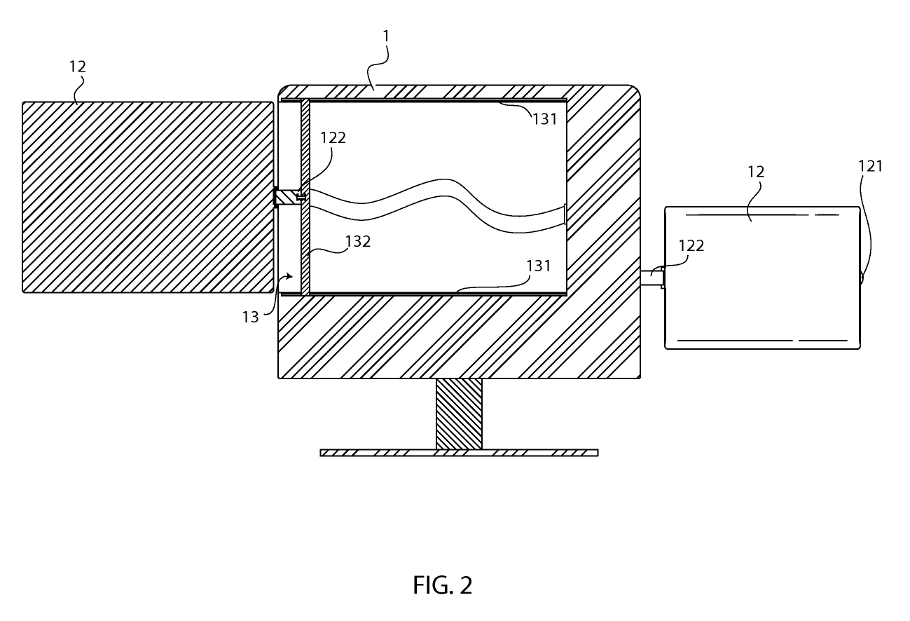

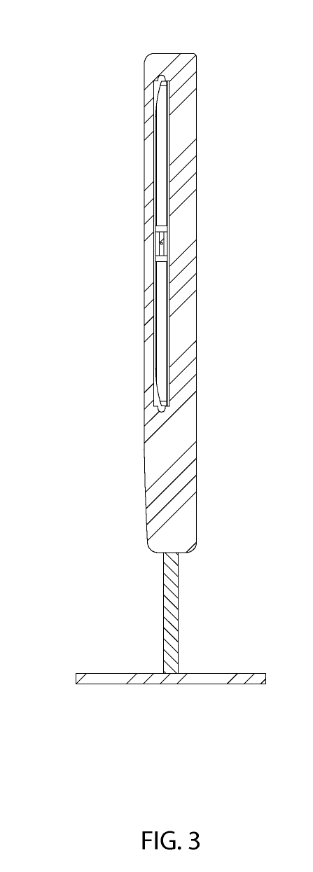

In reference to FIG. 2 and FIG. 3, each of the screen slots 13 of the display housing 1 comprises an arm track 131 and a track mount 132. The track mount 132 connects the extending arm 122 to the arm track 131 allowing the plurality of extended display screens 12 to be extracted from and retracted back into the display housing 1. In the preferred embodiment of the present invention, the extending arm 122 is jointly connected to the track mount 132 by a swivel connection. The swivel type of connection allows the user to tilt the extended display at a comfortable viewing angle. In the preferred embodiment of the present invention, the swivel is able to provide the extended display screens 12 with 360 degrees of freedom. The arm track 131 is a track within the screen slot 13 that is positioned in parallel relationship to the direction the screen slot 13 is recessed in. The track mount 132 is attached onto and is slidable on the arm track 131. The track mount 132 is able to freely move along the arm track 131, but is limited by the opening of the screen slot 13 to prevent the track mount 132 from falling out. The cables that transmits power and the video signals to the plurality of extended display screens 12 traverses through the track mount 132, the swivel, the extending arm 122, the joint connection to the extended display screen 12. The cables are connected to the main circuit of the present invention that distributes video signal based on the extended display screens 12 activated by the user through a screen selection interface 2.

In another embodiment of the present invention, the display housing 1 comprises an external screen mounting port with a video interface. In this embodiment of the present invention, the user may use an external display screen that can be attached onto the display housing 1 for an additional display. The user is able to add additional display screens by mounting the external display screen onto the external screen mounting port with the video interface. This allows the user to extend their display onto the external display screen to view additional applications for multitasking. The external display screens can be the display on music players, mobile phones, or a specialized external display device designed to correspond and mount onto the external screen mounting port.

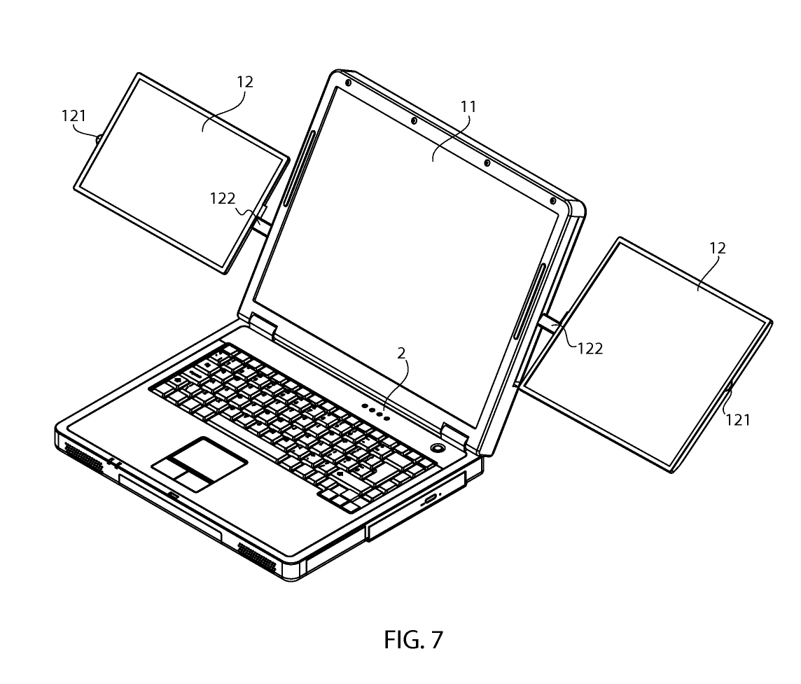

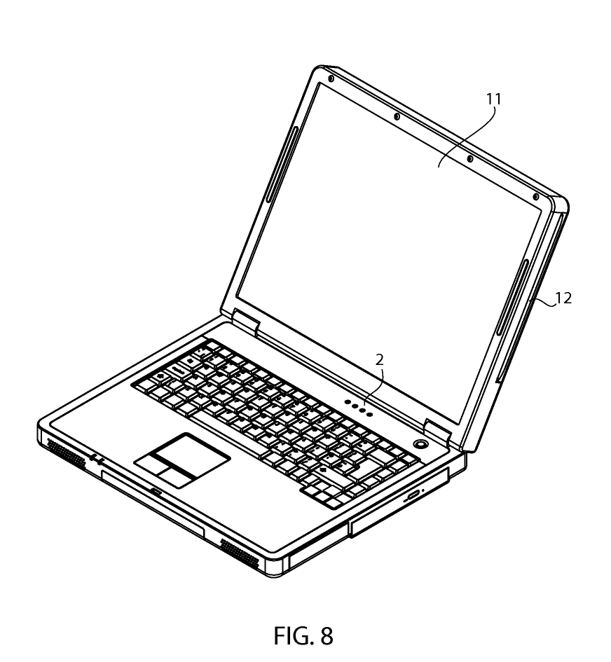

In reference to FIG. 1 and FIG. 7-8, the user is able to control the use of specific display screens by means of the screen selection interface 2. The screen selection interface 2 allows users to activate any screen they have chosen to use and deactivate screens when not in use. The screen selection interface 2 can be a set of buttons that the user can press on the display housing 1 to activate and deactivate the plurality of extended display screens 12. Each screen has a corresponding button for its activation and deactivation. When an extended display screen 12 is activated, the operating system on the user's computer will automatically extend their view onto the extended display screen 12 for additional viewing area. When activated, each of the extended display screens 12 are able to independently operate displaying different program applications. When the user is not utilizing certain extended display screens 12, the screens may be deactivated by the screen selection interface 2 and be retracted back into its corresponding screen slot 13 to conserve space and power.

Each of the plurality of extended screens can be shaped and sized differently depending on the manufacturer to provide a unique style or to accommodate unique software applications for unique users. For example, for a user who simple wishes to keep an eye out on stock quotes, a small screen extended display screen 12 can be used for viewing a stock application. For users who wish to watch movies while performing other tasks, a larger extended display screen 12 can be utilized for viewing pleasure. The plurality of extended screens and the plurality of screen slots 13 can be peripherally positioned anywhere on the display housing 1. This provides for maximum versatility as the user may have a display unit where extended display screens 12 can be pulled out from the top, bottom, left and right edge of the screen. In a retail setting, users are able to customize the types of display housing 1 with the types of extended display screens 12 they desire.

When the present invention is used on a laptop, weights are placed on the bottom of the keyboard to counteract the weight of the additional display screens. The weights ensure the weight of the entire laptop is evenly balanced. Although the invention has been explained in relation to its preferred embodiment, it is to be understood that many other possible modifications and variations can be made without departing from the spirit and scope of the invention as hereinafter claimed.

What is claimed is:

1. A multiple, independent, pull-out screens housed in a main display comprise,
a display housing;
a screen selection interface;
the display housing comprises a main display screen, a plurality of extended display screens, and a plurality of screen slots;
the plurality of screen slots comprises a track mount and a arm track;
the main display screen, the plurality of extended display screens, and the plurality of screen slots being positioned in the display housing;
the main display screen being positioned on a front face of the display housing;
the plurality of screen slots being recessed spaces peripherally positioned about the display housing; and
the plurality of extended display screens being positioned in the plurality of screen slots.

2. The multiple, independent, pull out screens housed in a main display as claimed in claim 1 comprises,
the plurality of extended display screens comprises a pull tab and an extending arm;
the extending arm being jointly connected peripherally to the plurality of extended display screens; and
the pull tab being positioned peripherally on the plurality of extended display screens opposite of the extended arm.

3. The multiple, independent, pull out screens housed in a main display as claimed in claim 2 comprises,
the extending arm being jointly connected to the track mount; and
the extending arm being attached to the arm track by the track mount.

4. The multiple, independent, pull out screens housed in a main display as claimed in claim 1 comprises,
the arm track being positioned within the plurality of screen slots in parallel relationship to the recessed space of the screen slots.

5. A multiple, independent, pull-out screens housed in a main display comprise, a display housing;
a screen selection interface;
the display housing comprises a main display screen, a plurality of extended display screens, and a plurality of screen slots;
the plurality of screen slots comprises a track mount and a arm track;
the main display screen, the plurality of extended display screens, and the plurality of screen slots being positioned in the display housing;
the main display screen being positioned on a front face of the display housing;
the plurality of screen slots being recessed spaces peripherally positioned about the display housing;
the plurality of extended display screens being positioned in the plurality of screen slots;
the plurality of extended display screens comprises a pull tab and an extending arm; and
the extending arm being jointly connected peripherally to the plurality of extended display screens.

6. The multiple, independent, pull out screens housed in a main display as claimed in claim 5 comprises, the pull tab being positioned peripherally on the plurality of extended display screens opposite of the extended arm. the extending arm being jointly connected to the track mount; and
the extending arm being attached to the arm track by the track mount.

7. The multiple, independent, pull out screens housed in a main display as claimed in claim 5 comprises,
the arm track being positioned within the plurality of screen slots in parallel relationship to the recessed space of the screen slots.

8. A multiple, independent, pull-out screens housed in a main display comprise,
a display housing;
a screen selection interface;
the display housing comprises a main display screen, a plurality of extended display screens, and a plurality of screen slots;
the plurality of screen slots comprises a track mount and a arm track;
the main display screen, the plurality of extended display screens, and the plurality of screen slots being positioned in the display housing;
the main display screen being positioned on a front face of the display housing;
the plurality of screen slots being recessed spaces peripherally positioned about the display housing;
the plurality of extended display screens being positioned in the plurality of screen slots;
the plurality of extended display screens comprises a pull tab and an extending arm;
the extending arm being jointly connected peripherally to the plurality of extended display screens;
the pull tab being positioned peripherally on the plurality of extended display screens opposite of the extended arm.
the extending arm being jointly connected to the track mount;
the extending arm being attached to the arm track by the track mount; and
the arm track being positioned within the plurality of screen slots in parallel relationship to the recessed space of the screen slots.
